(19) United States
(12) Patent Application Publication
(10) Pub. No.: US 2004/0019465 A1
(43) Pub. Date: Jan. 29, 2004

(54) Event router and method for handling events in distributing computing applications

(76) Inventors: James W. Kerr, Brooklyn, NY (US); Michael Ogg, West Windsor, NJ (US); Aleta Ricciardi, West Windsor, NJ (US)

Correspondence Address: Stuart D. Rudoler, Wolf, Block, Schorr and Solis-Cohen LLP, 22nd Floor, 1650 Arch Street, Philadelphia, PA, 19103, US

(21) Appl. No.: 10/435,797

(22) Filed: May 12, 2003

Related U.S. Application Data
(60) Provisional application No. 60/380,381, filed on May 13, 2002.

(51) Int. Cl. G06F 15/00

(52) U.S. Cl. 702/189

(57) ABSTRACT

The present invention is a method and system for automating the establishment of generator-listener communication within a distributed environment. A software module known as an event router monitors objects present in the distributed environment and registers listeners with generators according to a set of rules established within, or accessible to, the event router. In one embodiment the event router registers listeners with generators. In another embodiment the event router directs events to a Tuple Space.

### CROSS REFERENCE TO RELATED APPLICATION

The present application claims the benefit of U.S. Provisional Application No. 60/380,381 filed on May 13, 2003, the entire disclosure of which is incorporated herein.

### BACKGROUND OF INVENTION

A distributed system is a collection of autonomous computing entities, hardware or software, connected by some communication medium. While often the computing entities are geographically dispersed, in some instances they might be separate processors in a multi-processor computer or even separate software routines executing in logically isolated memory space on the same computer. A computing entity need not be a traditional computer, but more generally can be any computing device, ranging from a large mainframe to a refrigerator or a cell phone. A distributed application is an application that executes on a distributed system and one in which parts of the application execute on distinct autonomous computing entities.

Whenever a distinct component of a distributed application requests something (e.g., a data value, a computation) of another component, the former is called a client and the latter is called a service. It is worth noting that the terms service and client are not exclusionary in that an item can be both a client and a service. For example, a routine that calculates the time between two events may be a client of a clock service; if the clock service then calls a routine that converts to Daylight Savings Time, the clock becomes a client and the Daylight Savings Time converter is its service.

FIG. 1 shows a typical distributed application of the existing art. There are two clients 2, 4 and four services 10, 12, 14, 16 that the clients 2, 4 might need. Each service has a service proxy 10a, 12a, 14a, 16a which is a module of mobile code that can be used by clients to invoke that service. A service proxy 10a, 12a, 14a, 16a contains the code needed by a client 2,4 to interact with a service. For instance if a service is a digital camera on a robotic arm, the interfaces might include initialize( ), zoom( ), rotate( ) and get_Picture( ). The service proxy 10a, 12a, 14a, 16a may also provide the expected return values for the service, which might include error codes as well.

Mobile code generally refers to a computer program that can be written on one platform and executed on numerous others, irrespective of differences in hardware, operating system, file system, and many other details of the execution environment. In addition to independence from the physical characteristics of the execution environment, a mobile program may move from one computer to another in the middle of its execution.

Mobile code may be pre-compiled, or compiled when it arrives at the execution platform. In the first case, numerous versions of the program must be written and compiled, then matched across run-time environments; this is mobile code in the letter, but not the spirit, of the definition. In addition, the same pre-compiled program cannot move from one platform to a different one during its execution. In the second, the program text may be distributed along with configuration scripts describing what to do in each execution environment. This distributes and delays the specificity of the pre-compiled option. The more interesting, and far more common approach exploits a standard virtual machine, which finesses all the issues of platform heterogeneity. The virtual machine is a program that itself mitigates the machine dependencies and idiosyncrasies, taking the raw program text and compiling it to a binary executable.

In addition to clients 2, 4 and general services 10, 12, 14, 16, all distributed applications need some mechanism for clients 2, 4 to find services. Often such knowledge is assumed a priori, but many distributed applications use a look-up service 20. The look-up service 20 is a service with which the other services are registered or advertised to be available for use by clients. In a simple system, where there is no attempt to coordinate replicas of services, each new service registers with the look-up service 20 (in the case of replicas, the onus falls on the client to resolve conflicts and ambiguity). When a service 10, 12, 14, 16 registers, it provides information telling clients 2, 4 how to find it. Commonly, this is a physical location such as an IP address and port number, but in the most modem systems this can be as powerful as giving the look-up service 20 a service proxy 10a, 12a, 14a, 16a, which is actual mobile code that clients 2, 4 can execute and use to invoke that service 10, 12, 14, 16. In this way, the service proxy 10a, 12a, 14a, 16a contains not just location information but information for how to use the service 10, 12, 14, 16. While just as necessary for the client 2, 4 as location information, this has previously been assumed as a priori knowledge. When a client 2, 4 wishes to work with a service 10, 12, 14, 16 it finds it through the look-up service 20, downloads the service proxy 10a, 12a, 14a, 16a for that service 10, 12, 14, 16 from the look-up service 20, then uses the service proxy 10a, 12a, 14a, 16a to invoke the service 10, 12, 14, 16. The look-up service 20 may also have attributes of the services 10, 12, 14, 16, such as whether it is a grouped service, what type of group it is, what its cost to use is, how accurate it is, how reliable it is, or how long it takes to execute. In such cases the clients 2, 4 can use the attributes to decide which of a number of services 10, 12, 14, 16 it wishes to use.

Each of the foregoing has access to a communication network 22 so that it is capable of communicating with at least some of the other members in the distributed computing application. The communication network 22 may be wireless, a local area network, an internal computer bus, a wide area network such as the Internet, a corporate intranet or extranet, a virtual private network, any other communication medium or any combination of the foregoing.

In the prior art example shown in FIG. 1, one client 2 is a traffic monitoring program that notifies a user when and where traffic has occurred and the other client 4 is an automated toll collection program. The services are a clock 10, a road sensor 12 that monitors traffic flow on a highway, a toll booth sensor 14 that detects an ID device in each car that passes through the toll, and a credit card charge program 16. When each service 10, 12, 14, 16 becomes available to the application it registers with the look-up service 20 and provides the look-up service with its service proxy 10a, 12a, 14a, 16a.

When the traffic monitoring client 2 begins, it queries the look-up service to see if a clock is available and what sensors are available. The look-up service 20 responds by providing the client 2 with the clock proxy 10a, the road sensor proxy 12a and the toll booth sensor proxy 14a. The traffic monitoring client 2 uses the service proxies 10a, 12a, 14a to invoke the clock 10 and the sensors 12, 14, and then to monitor traffic at various times of the day.

Similarly when the toll collector client 4 begins, it queries the look-up service 20 to see if a toll booth sensor 14 and a credit card charge service 16 are available. The look-up service 20 responds by providing the client 4 with the toll booth sensor proxy 14a and the credit card charge proxy 16a. The toll collector client 4 uses the service proxies 14a, 16a to invoke the toll booth sensor 14 and the credit card charge program 16, and then to identify cars that pass through the toll booth and charge their credit cards for the toll.

Another technique known in the existing art is leasing. A lease is an important concept throughout distributed computing, generally used between a client and service as a way for the service to indicate its availability to the client for a length of time. At the end of the lease, if the lease is not renewed, there is no guarantee of availability. In a simple example, a service may register with a look-up service and be granted a lease for five minutes. This means that the look-up service will make itself available to the service (i.e., list it) for five minutes. If a camera grants a lease to a client for two minutes, then that client will be able to position, zoom, and take pictures for two minutes. There are a wide variety of ways to handle lease negotiation, renewal and termination which are well known to those skilled in the art of distributed computing and all such methods are meant to be incorporated within the scope of the disclosed invention. A detailed explanation of leases can be found in, Jim Waldo, The Jini Specification, 2nd Edition, chapter LE (2001), which is incorporated herein by reference.

Some benefits of distributed computing and mobile code can immediately be seen from this example. First, the clients 2, 4 in FIG. 1 do not need to know ahead of time which sensors 12, 14 are available, or even how many. They simply query the look-up service 20, which provides this information along with the necessary mobile code 12a, 14a to call the sensors. Similarly, the clients 2, 4 do not care which clock 10 is available, as long as any clock 10 is available. Again, this is because through the use of mobile code, a client 2, 4 is provided with the necessary service proxy 10a to invoke and work with the clock 10. Also, the failure or unavailability of a single sensor 12, 14 or other service is not likely to cause the entire application to stop running. Further, the processing load is distributed among a number of computing devices. Also, the various computing entities need not use the same operating system, so long as they conform to a common interface standard.

Jini is one example of a commercially available specification for a distributed object infrastructure (or middleware) for more easily writing, executing and managing object-oriented distributed applications. Jini was developed by Sun Microsystems and is based on the Java programming language; consequently, objects in a Jini system are mobile. Jini is described in Jim Waldo, The Jini Specification, 2nd Edition (2001). The Common Object Request Broker Architecture (CORBA), developed by the Object Management Group, and Distributed Component Object Module (DCOM), developed Microsoft Corporation, are two other commercially available examples that are well known in the prior art. Jini, DCOM, CORBA and a number of other distributed computing specifications are described by Benchiao Jai et al., Effortless Software Interoperability with Jini Connection Technology, Bell Labs Technical Journal, April-June 2000, pp. 88-101, which is hereby incorporated by reference.

Distributed computing systems with groups can also be found in the prior art, particularly in the academic literature. For example, Ozalp Babaoglu et al., Partitionable Group Membership: Specification and Algorithms, University of Bologna, Department of Computer Science, Technical Report UBLCS-97-1 describe groups, but assumes the services in the group are group-aware. Similarly static group proxies, or software wrappers, for clients have been described in Alberto Montresor et al. Enhancing Jini with Group Communication, University of Bologna, Department of Computer Science, Technical Report UBLCS-2000-16, but these group proxies cannot be modified during execution of the distributed application to accommodate changes in group make-up and structure.

Another well known concept in the prior art of distributed computing is that of a tuple space. Within the Java language Tuple spaces are specifically known as JavaSpaces. A Tuple space is a hybrid of a database, a file system and a librarian. Tuple spaces are active, in that they are not only capable of providing data if it is available, but can notify users when information they are looking for has been entered. Tuple spaces are repositories of objects. Applications can put an object into a Tuple space. This makes it available to other members in the distributed environment. Applications can query Tuple spaces to see if a particular object or type of object is in the space. Applications can subscribe to a Tuple space so that they are notified when an object or type of object they have requested is placed in the space. Applications can read or take objects from a Tuple space. The difference between reading and taking is that reading leaves the object in the space for other services to read or take, while taking removes the object from the tuple space. Typically the objects in Tuple spaces have been data or data files.

It is known in the prior art for objects to emit events upon the occurrence of certain conditions. An event is a message pushed by or from an object to one or more other objects that are capable of receiving and interpreting the event. The object sending the event is known as the generator, emitter or source. The object receiving the event is known as the listener. Events may be emitted upon the change of any state in an object. Examples of events are occurrence of an error, the successful completion of all or part of a task, a security breach or a periodic notice that the emitter is still functioning.

In the prior art, listeners have been hard-coded to receive events of importance to them; this has been achieved by invoking a file transfer protocols (reading a file of events), initiating a socket or other communication session with the event source, or subscribing to an event stream. In a Jini system, a listener may use the discovery protocol and the look-up service to find generators of events of specific types (e.g., all alarm events, or all complete events). The listener then registers with the event generators for some or all events available and the event generator notifies the listener upon the occurrence of the stated events. In registering for the event the listener gives the generator its proxy so that the generator has the appropriate communication syntax and protocol to communicate with the listener. The use of the events in distributed systems is well known in the prior art and is described in Jim Waldo, The Jini Specification, 2nd Edition, Chapter EV (2001), which is incorporated herein by reference.

### BRIEF DESCRIPTION OF THE INVENTION

The present invention is a method and system for automating the establishment of generator-listener communication within a distributed environment. A software module known as an event router monitors objects present in the distributed environment and registers listeners with generators according to a set of rules established within, or accessible to, the event router.

### BRIEF DESCRIPTION OF THE DRAWINGS

FIG. 1 shows an example of a distributed computing application of the prior art.

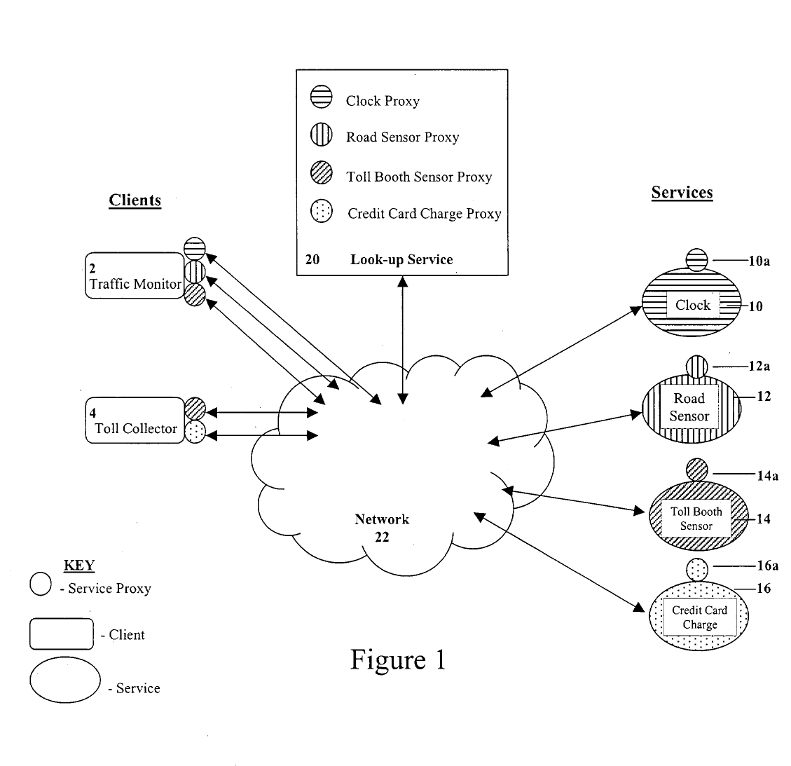

FIG. 2 shows a block diagram of a distributed system with a plurality of sources and listeners and an event router.

FIG. 3 shows an example of an event router routing events to a JavaSpace.

### DETAILED DESCRIPTION OF THE INVENTION

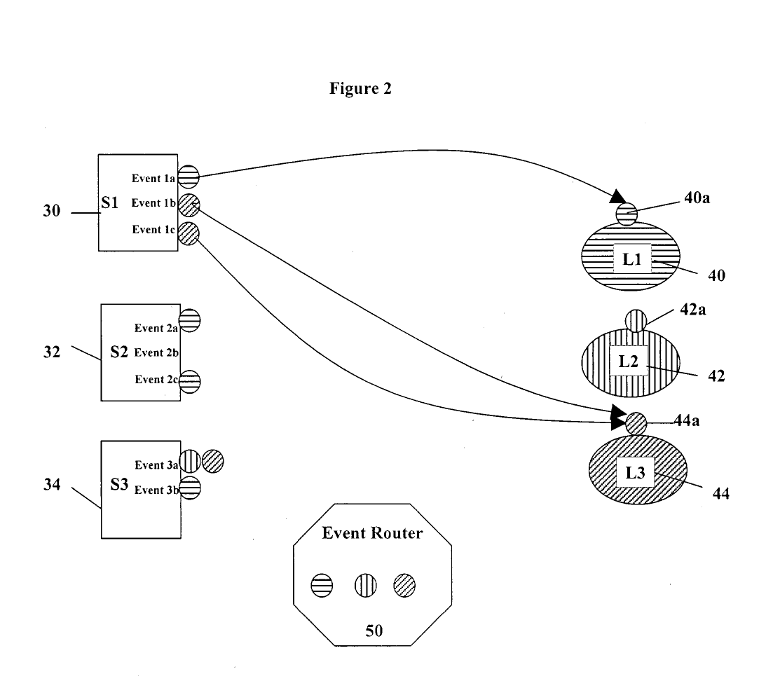

The present intervention is a software module termed an event router. The event router is used to establish connections between event generators and event listeners without affecting listeners; the rules determining which generators and listeners are connected are dynamically modifiable and may be accessed by the event router from other modules, thus enabling modules with specific environmental analytics to influence the routing of events. The event router may also provide wrappers for listeners' proxies that can enhance the generator-listener connection. For example, the wrapper may perform all tasks associated with maintaining the generator-listener connection (e.g., in a Jini system, the listener is given a lease which must be renewed if the connections with the generator is to be maintained). In general, the event generator removes the burden from listeners of explicitly having to register with event generators, making the connection to generators dynamic and controllable according to ambient conditions. The distributed system implementing the invention is disclosed in FIG. 2.

In the present embodiment, the event router 50 observes which objects enter the distributed environment. It does this either by using a discovery protocol or checking with look-up services. It contains within it a set of rules that describe which generators and which listeners to connect, as well as which events within a particular generator it should have listeners subscribe to. Alternately, it may retrieve those rules dynamically from one or more specialized services. In the preferred embodiment these rules may be dynamically modified.

In FIG. 2 object, L1 40, L2 42 and L3 44 are listeners. The even router 50 stores the proxies 40a, 42a, 44afor each of these listeners. Objects S1 30, S2 32 and S3 34 emit events. The event router knows from its internal rules which types of events to route to which types of listeners. In the example, each source emits a number of events, although sources may emit only one type of event. The event router 50 distributes the appropriate proxies to each source so that each event is routed to the appropriate listener according to a set of rules. In FIG. 2, each event is transmitted to the listener whose proxy (or proxies) is attached to it. The proxies in the figure can be distinguished by the internal hash lines (horizontal, vertical, diagonal). Each proxy has the same hash marks as its listener. The table below shows the routing for FIG. 2.

| Event | Listener |
|---|---|
| 1a | L1 |
| 1b | L3 |
| 1c | L3 |
| 2a | L1 |
| 2b | none |
| 2c | L1 |
| 3a | L2, L3 |
| 3b | L1 |

The arrows in FIG. 2 indicate the event communication path for S1 events (S2 and S3 paths are not shown). Note that some events may have multiple listeners (Event 3a) or no listeners (Event 2b) and listeners may listen to multiple events from multiple sources.

For example, one listener may be a security monitor and may want to be notified of any time that a user enters into the distributed environment. The event router would know that certain types of object, which are generators, are capable of logging in and admitting users. In this example, assume there are different objects that handle local login, remote login through dial-up access, and login through internet access; when any of these objects are present, they are identified as generators and the event router uses a rule to connect their events to the security module, which is the listener. Another object may want to listen for all events in the system and write these to a log. This object would be connected by the router to every other object in the system that emits events.

The advantage can be readily seen which is instead of each listener having to discover each and every object in the system and subscribe to event notification, the event router 50 handles this task across the system. The event router 50 can have very simple policies or complex policies, or it could retrieve (updated) policies from other services. Also, instead of these policies being written into each listener, they are written into the event router 50. In this particular embodiment, the event router 50 downloads the proxy 40a, 42a, 44a for each listener 40, 42, 44 and distributes it to the appropriate generators 30, 32, 34 so that generators can transmit events directly to the listener. The event router 50 is not involved in the transmission path of event notification, nor does it, in the preferred embodiment, determine the rules for establishing connections. In an alternate embodiment it may determine the rules using its own software.

Generators and listeners need not be software, but may be hardware, firmware, or a combination of software, hardware and firmware. As an example communication network hardware (such as signal routers) often emit events to announce occurrences such as errors, capacity levels, switching, status or merely pulses that they are alive. Various software modules may be interested in receiving these events. A system log service may want to receive all events from a piece of network hardware. A security service may only want to receive security alerts from those pieces of hardware that issue security events. A system status service may wish to receive status events from all hardware routers. Each of these rules would be entered into the event router. These rules can be very specific (connect hardware piece 732 to the ABC security monitors) or more general (connect all firewalls to any security monitor). As each listener enters the system, the event router downloads its proxy. When a generator that the listener should register with (based on the rules) enters the system, the event router distributes the listener's proxy to the generator.

In the preferred embodiment the polices in the event router can be changed dynamically by an operator or another object in the distributed environment.

An object can be both a source or a listener with respect to other objects in the distributed application.

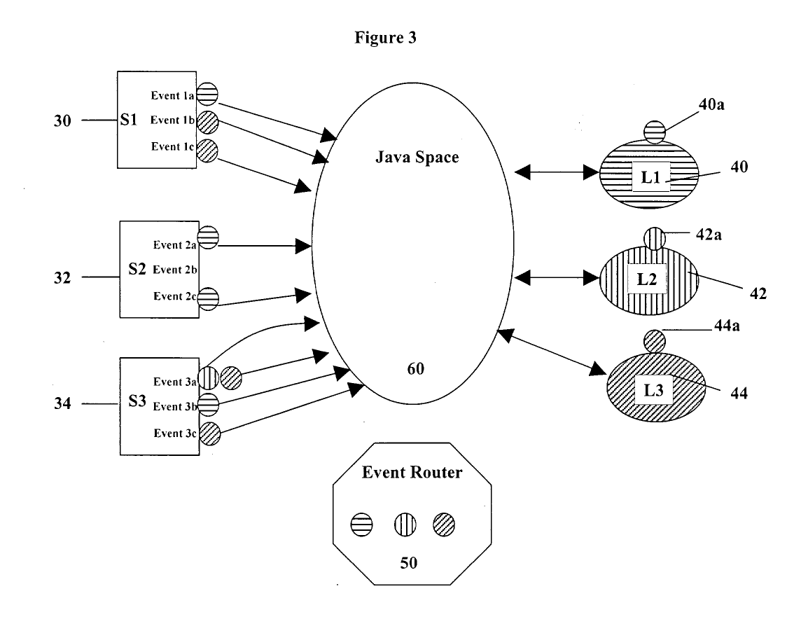

The event router may also redirect certain notices to logs or to Tuple spaces (also known as JavaSpaces within Jini Applications) as shown in FIG. 3. Now instead of all events going to particular listeners, the events are deposited within the JavaSpace where the listeners can monitor to see if any relevant events occurred. One advantage of this particular implementation is that load on the generator is minimized: the event generator produces and transmits only one event, rather than transmitting one for each listener (this is done when the listeners take relevant events from the JavaSpace). Another advantage derives from the event router's wrapper; since events in a JavaSpace are leased, the wrapper can renew the event's lease with the JavaSpace for a designated period of time, or even until it is taken from the JavaSpace.

Numerous advantages pertain to systems with an event router. First event listeners do not need to register with generators. The event router performs this task, as well as any other tasks associated with establishing and maintaining the generator-listener relationship. This adds flexibility to an executing system in that generator-listener relationships need not be predicted or known in advance (only event types) and allows listeners to perform only the task of listening and event processing, rather than connection establishment and maintenance. Another advantage is that the event router can enforce system-wide security policies by connecting only authorized or authenticated listeners with generators. Another advantage is that the event router's wrappers enhance listeners'proxies. Finally, the ability of the event router to access routing rules from other services means that the set of generator-listener relationships can be modified as required by the conditions in the system at any given time.

Examples of generator-listener relationship rules for an event router are:

Network Elements

Find all network element Jini services and register a listener that places all generated events in a JavaSpace

Find all network element Jini services that emit a PacketLossAlarm event and register both the “AlarmSpace” and the NetworkAdministrator listeners.

Billing System Security

Connect all services that emit UserAuthentication events with all SystemAdministrator, SecurityLog, and UsageDisplay listeners.

Failure Detection

Connect all services that emit LeaseExpired and RemoteMethodException events with all FailureDetector listeners.

While the disclosed embodiments have shown a single event router, multiple event routers may be used either for redundancy, to handle different sets of objects, or to implement different policies.

The invention may also be practiced in combination with groups of objects, with a group acting as either an event source or listener.

It is understood that the invention is not limited to the disclosed embodiments, but on the contrary, is intended to cover various modifications and equivalent arrangements included within the spirit and scope of the appended claims. Without further elaboration, the foregoing will so fully illustrate the invention, that others may by current or future knowledge, readily adapt the same for use under the various conditions of service.

We claim:

1. A distributed computing system comprising
a plurality of event generators;
a plurality of event listeners;
an event router;
a set of connection rules;
wherein the event router detects the event generators and event listeners and connects the event generators and events listeners according to the connection rules.

2. The distributed computing system of claim 1 wherein a connection is made by registering an event listener with an event generator.

3. The distributed computing system of claim 1 wherein a connection is made by directing events to a Tuple Space.

4. The distributed computing system of claim 1 wherein the event generator is a status monitor, network hardware, or system login module.

5. The distributed computing system of claim 1 wherein the event listener is a log service, security monitor, e-mail or beeper.

6. A method of monitoring events in a distributed computing system comprising:
an event router discovering objects in the system;
the event router applying a set of rules to the objects to determine which of the objects are event generators and which objects are event listeners; and
the event router connecting an event generator to an event listener.

7. The method of claim 6 wherein the step of connecting the event generator to the event listener is comprised of registering the event listener with the event generator.

8. The method of claim 6 wherein the step of connecting the event generator is accomplished via a Tuple Space.
